(19) United States
(12) Patent Application Publication
(10) Pub. No.: US 2025/0017403 A1
(43) Pub. Date: Jan. 16, 2025

(54) DRINKING STRAW CONTAINING DEXTRIN BASED MATRIX

(71) Applicant: Happycure Corporation, Sheridan, WY (US)

(72) Inventor: Joseph Noel, Cerritos, CA (US)

(21) Appl. No.: 18/761,143

(22) Filed: Jul. 1, 2024

Related U.S. Application Data
(60) Provisional application No. 63/512,215, filed on Jul. 6, 2023.

(51) Int. Cl. A47G 21/18; A23L 2/56; A23L 2/58; A23L 2/60; A23L 27/00

(52) U.S. Cl. CPC A47G 21/183; A23L 2/56; A23L 2/58; A23L 2/60; A23L 27/75

(57) ABSTRACT

A paper drinking straw is designed explicitly to deliver flavorings or active ingredients, or a combination of flavorings and active ingredients to the user of the paper straw. The paper straw is lined with a dried coating designed to adhere to the unique properties of the inside of a paper drinking straw. The paper straw lining includes a combination of dextrin, low levels of food-grade acids, and low levels of cellulose gums or no cellulose gums, or a combination of these elements combined with or without an active ingredient. The lining, which optionally includes sweeteners, colorings, and/or flavorings, is prepared as a gel-like liquid that is added to the interior of the paper straw and is then dried, creating a lining within the paper straw that dissolves as the user draws water or beverage through the straw, thus delivering the flavorings and/or active ingredients to the user.

The present Application for Patent claims priority to U.S. Provisional Application No. 63/512,215 entitled “Drinking Straw Containing Dextrin Based Matrix”, filed Jul. 6, 2023, which is hereby expressly incorporated by reference.

### TECHNICAL FIELD

Embodiments are generally related to a paper drinking straw containing a dextrin-based flavoring matrix that bonds readily to the inside surface of the drinking straw.

### BACKGROUND

The burgeoning realm of paper straws represents a thriving industry that offers a sustainable substitute for plastic counterparts, which are increasingly being banned in multiple jurisdictions. Crafted from biodegradable materials like paper, bamboo, or other mainly natural fibers, these straws leave no ecological footprint upon disposal.

The realm of paper straws is rapidly expanding in response to heightened public awareness regarding the lack of, or limited, recyclability of plastic straws, the significant adverse effects on marine life, and other harmful environmental consequences, especially relating to microplastic induction into humans and non-human organisms. Numerous nations across the globe and many jurisdictions within the United States are imposing bans or limitations on plastic straws, thus amplifying the demand for paper or natural fiber alternatives. Furthermore, an increasing number of establishments, including restaurants and cafes, are embracing paper straws as part of their commitment to sustainability.

Filled straws, readily available in supermarkets worldwide, present a pragmatic solution for enhancing the flavor profile of beverages. These straws are typically equipped with pellets imbued with sweeteners and flavorings, including popular options such as strawberry or chocolate. Primarily intended for milk consumption, these straws facilitate a gradual dissolution of the pellets as the milk is drawn through the straw, resulting in an augmented sensory experience characterized by enhanced flavor and sweetness. Using such straws entails distinct advantages compared to alternative methods, encompassing a compact assortment of flavors, an extended shelf life surpassing that of flavored milks, and a user-friendly and precisely regulated approach as opposed to the laborious process of dissolving milk flavoring powder. Notably, these straws also infuse water with taste enhancements. Other forms of filled straws have also been outlined using dissolvable coatings that are applied to the interior wall of the straw. As the beverage is taken up through the straw, the lining dissolves, thus delivering flavorings and/or active ingredients.

However, there are disadvantages to the current approaches using pellets or dissolving linings. The use of pellets adds costs to the straw, and the manufacturing process requires highly specialized equipment. The past generations of straws designed with dissolving linings offered mixed results in the time to reach full dissolution of the lining, and there may be poor adhesion to the filling to the side of the straw. This latter issue may be addressed by adding a large amount of edible acid to the filling in order to promote adhesion. However, a large amount of edible acid may affect the taste of the filling, the viscosity of the filling when filling the straw and add additional expense.

Accordingly, there is a need in the art for straws having fillings with optimal taste properties and good adhesion to the inside of the straw.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments pertains to a drinking straw that includes a hollow tube having an outside and an inside; a matrix coating the inside, the matrix comprising dextrin; and at least 1 flavor or active ingredient component in the matrix.

In the disclosure, the dextrin may be fibrous water soluble dextrin. The hollow tube can be formed from at least one of paper fibers, cellulose fibers, sugar cane fibers, hemp fibers, cellulose fibers, bamboo fibers, or other natural fiber utilized to make a paper-like composition.

In the disclosure, matrix may contain at least one sweetener or flavoring agent and/or at least one edible dye. The matrix may not contain active ingredients selected from the groups consisting of pharmaceutical substances, botanical extracts and vitamins. The matrix may have less than 20 ppm gluten. The matrix may not contain cellulose gels. The flavor component may contain at least one flavoring selected from cherry, strawberry, raspberry, blueberry, blackberry, apple, orange, pear, lemon, lime, vanilla, chocolate, mint and pistachio. The matrix contains at least one natural edible dye selected from annatto, caramel carmine elderberry juice, lycopene paprika and turmeric. The matrix may contain at least one artificial edible dye selected from FD&C Blue No. 1, FD&C Blue No. 2, FD&C Green No. 3, FD&C Red No. 3, FD&C Red No. 40, FD&C Yellow No. 5, and FD&C Yellow No. 6. The matrix may contain at least one natural derived natural coloring agent. The hollow tube may be formed from an elongated tubular body made of a single layer or multiple layers of paper.

Another aspect of the disclosure pertains to a method of manufacturing a drinking straw, that includes providing a hollow tube having an outside and an inside; preparing a matrix by dissolving dextrin in water to prepare a paste, slurry or syrup; coating the inside of the tube with the paste, slurry or syrup; and drying the coated matrix.

In the method, the hollow tube can be paper formed from at least one of cellulose fibers, sugar cane fibers, hemp fibers, or bamboo fibers. The matrix may contain no active ingredients selected from the groups consisting of pharmaceutical substances, botanical extracts and vitamins. The matrix may further include at least one of a dye or a flavoring. The matrix may be prepared at about 20° C. The matrix may be heated to about 48° C. before coating the inside of the tube.

### BRIEF DESCRIPTION OF THE DRAWINGS

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 depicts a drinking straw according to an embodiment of the disclosure.

FIG. 2 depicts a bent drinking straw according to an embodiment of the disclosure.

FIG. 3 is a photograph showing water absorption of dextrin versus PHGG.

FIG. 4 is a photograph showing matrix formation of dextrin versus PHGG.

FIG. 5 is a photograph showing water penetration of matrices of dextrin versus PHGG.

FIG. 6 is a photograph showing drying of matrices of dextrin versus PHGG.

### DETAILED DESCRIPTION

The particular values and configurations discussed in the following non-limiting examples can be varied and are cited merely to illustrate one or more embodiments and are not intended to limit the scope thereof.

The present disclosure pertains to a drinking straw, the insides of which are coating with a matrix that does not contain gums such as partially hydrolysed guar gum (PHGG) and minimizes the amount of edible acid.

Conventionally, drinking straw fillings required very high levels of food acid usage to aid in adhesion. The present disclosure operates well below what is needed to optimize the formulation for use with plastic straws. In the conventional art, partially hydrolyzed guar gum (PHGG) must be augmented with significant amounts of food acid (such as citric acid) so that it will stick to the wall of a plastic straw. It has been found that PHGG must be augmented with significant amounts of food acid (such as citric acid) so that it will stick to the wall of a plastic straw and to prevent over-drying of the lining. Neither of these issues pertain to paper straws as dextrin readily sticks to the interior lining of paper straws and continues to cling to the inside upon drying, thus augmentation of high amounts of food acids are not required.

That is, the conventional art requires high levels of food acid to prevent drying of the straw lining so it does not crack as the wall of a plastic straw flexes. Paper straws don't flex. The disclosure outlines a formulation requiring significantly lower levels of added food acid to maintain the integrity of the interior lining. The rigidity of dextrin makes the paper straws stronger. The conventional art relies on adding food acid to force flexibility to increase survivability. In the disclosure, a stable formulation is obtained via dextrin, thus high levels of food acids are not needed.

In order to prepare the matrix to be utilized as the lining of the straw, dextrin, along with other ingredients, is mixed into water to create a viscous syrup. Dextrin is superior to PHGG in its water solubility and the speed at which solubility occurs. Experiments outline that dextrin will fully dissolve in water at a rate at least ten times as fast as PHGG and in a significantly lower volume of water. This yields substantially faster process times and a more consistent matrix that is smoother and free of lumps, which not potentially results in a smoother finish within the straw but also potentially fewer issues with clogging of the production equipment, which extrudes the liquid matrix into the straw. The disclosure demonstrates that dextrin is a superior ingredient for paper straws because of this issue.

Water penetration is not an issue for plastic straws but a significant issue for paper straws. Dextrin fibers cling to the paper fibers—but so does PHGG. The big difference is that a matrix using dextrin can be created utilizing less than 50% of the water required to create a matrix of similar viscosity using PHGG. Thus, a matrix formed from dextrin allows for significantly less wicking of water in the fiber of the paper straw, thus not promoting deterioration of the paper fibers during manufacturing and processing. Additionally, with less than 50% of the water utilized, drying times are reduced thus allowing for fast manufacturing and curing cycles. The disclosure demonstrates that because of this issue, dextrin is a superior ingredient for paper straws.

The conventional art teaches the use of high levels of cellulose gum. When the disclosure uses cellulose gum, it is at levels 80% or less than the conventional art. The level of cellulose gum can be as low as 0%. Whereas the interior of plastic straws are smooth and thus yield relatively low levels of adhesion, the interior walls of paper straws are naturally porous allowing the gel matrix to more easily stick. Thus, whereas the prior art outlines the use of various types of cellulose gum to relative to adhesion and the handling of the matrix material, this disclosure utilizes cellulous level between about zero (0) weight % and three (3) weight %.

Approaches in the conventional art include a straw that adds flavor to neutral liquids like water or milk. Different methods are discussed, including a separate chamber for flavoring material, granules held by sponges inside the straw, and flavoring material adhered to the straw's interior. In another approach, an internally coated straw is manufactured by applying the coating to the inside of the straw during extrusion. The coating contains a matrix agent, such as maltodextrin or alginate, with added flavoring. Also known is a drinking straw coated on the inside to flavor and sweeten the beverage. The coating consists of an adhering agent and a powdered agent, including lipids, oils, emulsifiers, sweeteners, flavorings, vitamins, minerals, and more. However, these coatings outlined above have weak flavor or are not economically feasible for commercial production.

One may consider an edible straw made of fruit film layers wound together, which dissolve as the fluid passes through, adding flavor. The remaining straw material can be dissolved or eaten. A filled straw may have barriers or filters to retain the filling while allowing fluid to dissolve it. However, these additional steps increase manufacturing time, cost, and choking risks.

A coated straw has a coating that contains a food-grade acid, along with a surface tension-reducing agent, plasticizer, bulk agent, and water. A second powder coating includes acid, sugar, fizzing agents, colorants, probiotics, vitamins, herbs, and flavoring agents. A modified cellulose-based matrix in drinking straws dissolves over time, providing flavor during consumption. However, it is not effective for quickly consumed beverages with smaller volumes. Alternatively, a conventional drinking straw has an internal coating containing a matrix of food-grade gum, formed of partially hydrolyzed guar gum (PHGG), an acid, and modified cellulose, where acid is from 20-40% of the matrix, and the ratio of modified cellulose to PHGG is between 5% and 20%.

In the drinking straw of the disclosure there are no gums present such as PHGG. The straw of the disclosure includes dextrin and optionally a modified cellulose, or no modified cellulose, and less than 20% acid.

The matrix can also include a dye. Natural food dyes include Annatto (E160b), a reddish-orange dye made from the seed of the achiote, Caramel coloring (E150a-d), made from caramelized sugar, Carmine (E120), a red dye derived from the cochineal insect, Dactylopius coccus, Elderberry juice (E163), Lycopene (E160d), Paprika (E160c) and Turmeric/curcumin (E100). Artificial colorants approved by the FDA include FD&C Blue No. 1—Brilliant blue FCF, E133 (blue shade), FD&C Blue No. 2—Indigotine, E132 (indigo shade), FD&C Green No. 3—Fast green FCF, E143 (turquoise shade), FD&C Red No. 3—Erythrosine, E127 (pink shade, commonly used in glacé cherries), FD&C Red No. 40—Allura red AC, E129 (red shade). FD&C Yellow No. 5—Tartrazine, E102 (yellow shade), and FD&C Yellow No. 6—Sunset yellow FCF, E110 (orange shade).

The matrix can include a sweetener. Sweeteners include sugars such as monosaccharides that include glucose, fructose, and galactose. The major disaccharides include sucrose (one glucose molecule and one fructose molecule), lactose (one glucose molecule and one galactose molecule), and maltose (two glucose molecules). Other sugar products include agave syrup, arabinose, Barbados sugar, barley malt syrup, barley malt, barley sugar, beet sugar, birch syrup, brown sugar, molasses, cane sugar, carob syrup, caster sugar, coconut sugar, corn sugar, corn syrup, date sugar[, dehydrated cane juice, and demerara sugar. Artificial sweeteners may include aspartame, monk fruit extract, saccharin, sucralose, stevia, and cyclamate.

The matrix may contain protein based thickeners such as collagen, egg whites, and gelatin. A viscosity modifier may be added to the matrix, such as hydroxypropyl cellulose. An emulsifier such as lecithin or carrageenan may be added to the matrix, as well as polyglycerol esters (PGE), polysorbates, stearoyl lactylates, propylene glycol esters (PGMS), and sucrose ester. Edible oils may be added to the matrix, including olive oil, peanut oil, canola oil, corn oil, and sunflower oil.

The matrix may contain flavors including cherry, strawberry, raspberry, blueberry, blackberry, apple, orange, pear, lemon, lime, vanilla, chocolate, mint, pistachio, etc. The flavorings may be natural or artificial flavorings.

The present disclosure is markedly different from the conventional art in that the formulation of the coatings is optimized explicitly for the unique properties in the interior wall of a hydrophilic and porous interior wall of a paper or natural fiber straw. In contrast, prior art primarily optimizes formulations for compatibility with the hydrophobic and impermeable walls of a plastic or plastic-like drinking straw.

Aqueous materials tend to shrink upon drying, making adherence to a plastic straw's hydrophobic material difficult. This shrinking can cause the matrix that had adhered to the inner wall of the plastic straw to lift away upon drying and thus potentially fall out of the plastic straw, not only reducing the effectiveness of the product but also potentially causing the customer a poor user experience as the lining of the straw is seen in the bottom of the plastic straw's package. The conventional art addresses such issues primarily through acid etching inside the straw or via the direct addition of relatively high levels of food acids to boost adhesion.

An additional issue the conventional art has addressed is the over-drying of the lining within the plastic straw. If the lining dries excessively, the lining can become brittle, and as the plastic straw is packaged, shipped, or handled by the consumer piece of the lining can crack off, again reducing effectiveness and creating less than optimal user experience. Prior art again primarily addresses these issues with the addition of relatively high levels of food acids that prevent complete drying of the lining, thus reducing chances of brittleness. This purposeful drying prevention regimen creates the potential for the lining never to dry sufficiently to fully adhere to the plastic straw's inner wall causing the potential for the contents to flow out of the plastic straw and into the package during shipment. Additionally, a straw lining that is not fully dry could harbor bacterial growth.

The challenges and solutions outlined above primarily relate to finding a coating agent that adheres to the inside of a plastic straw, overcoming issues of shrinkage, over-drying, and under-drying while still allowing for acceptable timeframes for the dissolution of the lining to conform with the time it takes for the human user to consume the beverage into which the straw was inserted.

The use of relatively high levels of modified cellulose gums to create gelling of the lining matrix to improve the handling of the materials and/or to engineer dissolution timeframes are also not required for gel matrix formulations for paper drinking straws. The use of high levels of cellulose compounds causes additional expense and potentially slows dissolution times to unacceptable levels, thus reducing the effectiveness of the straw. Additionally, consumption of high levels of cellulose gums could cause digestive issues and alter levels of beneficial bacteria and nutrients in the human gastrointestinal tract.

This disclosure pertains to formulations comprised of active ingredients and/or active ingredients and flavorings, sweeteners engineered explicitly for use in paper straws to create an internal coating utilizing low levels of food-grade acids and cellulose gums, and dextrin as the primarily dissolving matrix component to create an interior coating that increases the strength of the products, reduces costs and improves handle-ability, while quickly dissolving as beverages are drawn through the paper straws.

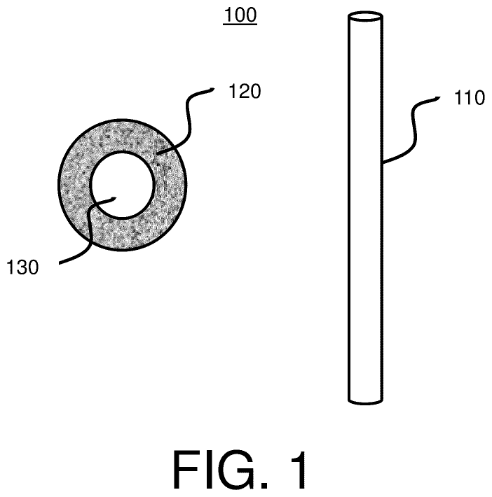

FIG. 1 depicts a side view and a cross sectional view of a drinking straw 100 according to an embodiment of the disclosure. The drinking straw 100 is formed from a hollow cylindrical tube 110 that may be formed from paper or plastic, preferably from paper. The interior of the tube contains a matrix based upon a fibrous material, for example dextrin, and can also contain, flavoring, sweeteners, etc. The center of the tube has a hollow chamber 130 traversing the length of the tube, which permits liquid to be drawn through the tube.

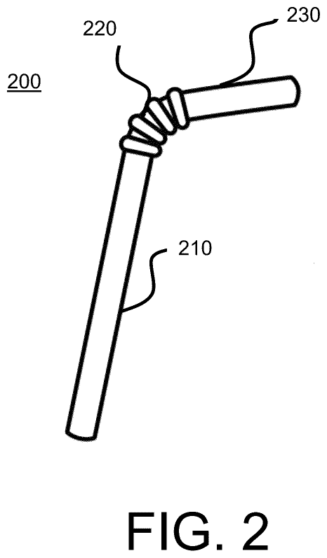

Another embodiment shown in FIG. 2, which shows is a bent drinking straw 200 that has a lower section 210 configured to be placed in a liquid, a corrugated bending section 220 and an upper section 230 configured for the user's mouth. The matrix may only coat the lower section 210.

The paper drinking straw 100, 200, is formed from an elongated tubular body, which may be made of multiple layers of paper. The internal coating of the paper straw typically consists of a matrix infused with active ingredients with or without sweeteners, colorings, and/or flavorings, prepared as a gel-like liquid that is added to the interior of the paper straw and is then dried, creating a lining within the paper straw that dissolves as the user draws liquid through the straw, thus delivering the flavorings and/or active ingredients to the user. Alternatively, the internal coating of the paper straw contains no active ingredients and instead is made of only flavorings, sweeteners, colorings, or similar substances without any active ingredients, pharmaceutical substances, botanical extracts, or similar substances.

In particular, the present disclosure pertains to a novel drinking straw that is 100% compostable or recyclable, made from multiple layers or a single layer of paper fibers, cellulose fibers, sugar cane fibers, hemp fibers, bamboo or bamboo fibers, any similar plant fibers or other natural fiber utilized to make a paper-like composition. Notably, the straw features an internal coating that delivers active agents and/or flavorings, sweeteners, or colorings, or a combination of these items, or only flavorings, colorings and/or sweeteners, which are evenly dispersed on the inner wall of the paper straw or a partially dispersed in the inner wall of the paper straw. As the liquid passes through the paper straw, the lining dissolves, releasing the combination of ingredients to be ingested by the person using the paper straw. The internal coating consists of substances specifically included to optimize the delivery of the active ingredients and/or flavorings, sweeteners, or colorings. Specifically, the primary ingredient is dextrin, a water-soluble fiber hydrolyzed starch made from wheat. Alternatively, other forms of dextrin could be utilized, such as those derived from corn, potato, arrowroot, rice, or tapioca.

Dextrins are a group of low-molecular-weight carbohydrates produced by the hydrolysis of starch and glycogen. Dextrins are mixtures of polymers of D-glucose units linked by α-(1-→4) or α-(1-→6) glycosidic bonds, as is shown in Formula 1:

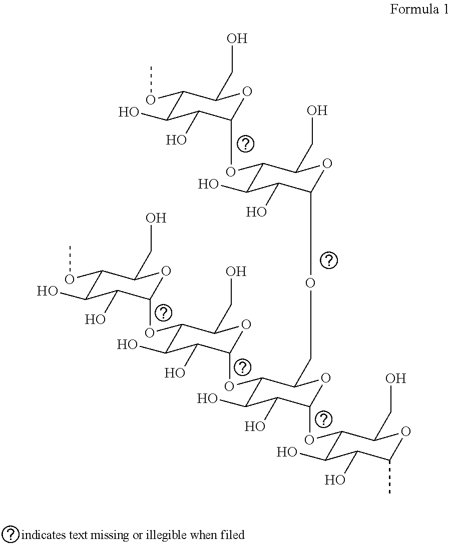

Dextrins can be produced from starch using enzymes like amylases, as during digestion in the human body and during malting and mashing, or by applying dry heat under acidic conditions (pyrolysis or roasting). This procedure was first discovered in 1811 by Edme-Jean Baptiste Bouillon-Lagrange. The latter process is used industrially, and also occurs on the surface of bread during the baking process, contributing to flavor, color and crispness. Dextrins produced by heat are also known as pyrodextrins. Starch hydrolyses during roasting under acidic conditions, and short-chained starch parts partially rebranch with α-(1,6) bonds to the degraded starch molecule.

Dextrins are white, yellow, or brown powder that are partially or fully water-soluble, yielding optically active solutions of low viscosity. Most of them can be detected with iodine solution, giving a red coloration; one distinguishes erythrodextrin (dextrin that colours red) and achrodextrin (giving no color).

Maltodextrin may also be used in the technology of the disclosure. Maltodextrin is a polysaccharide that is used as a food ingredient. It is produced from grain starch by partial hydrolysis and is usually found as a white hygroscopic spray-dried powder. Maltodextrin is easily digestible, being absorbed as rapidly as glucose and may be either moderately sweet or almost flavorless (depending on the degree of polymerization). It can be found as an ingredient in a variety of processed foods.

Maltodextrin is formed from of D-glucose units connected in chains of variable length. The glucose units are primarily linked with α(1-→4) glycosidic bonds, like that seen in the linear derivative of glycogen (after the removal of α1,6-branching). Maltodextrin is typically composed of a mixture of chains that vary from three to 19 glucose units long, as can be seen in Formula 2:

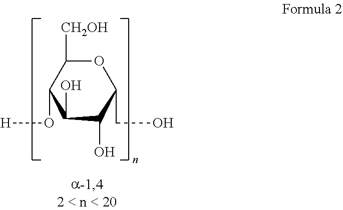

Maltodextrins are classified by DE (dextrose equivalent) and have a DE between 3 and 20. The higher the DE value, the shorter the glucose chains, the higher the sweetness, the higher the solubility, and the lower the heat resistance. Above DE 20, the European Union's CN code calls it glucose syrup; at DE 10 or lower the customs CN code nomenclature classifies maltodextrins as dextrins.

Dextrin is combined with inert or active ingredients, such as pharmaceuticals, botanical extracts, vitamins, minerals, certified USDA hemp extracts, and/or nutraceuticals, with or without flavorings, sweeteners, or colorings, combined with relatively low food-grade acids, with or without cellulose gels to form a liquid matrix which is applied onto the inner wall of a paper drinking straw that is then dried.

Notably, the matrix has relatively low levels of food-grade acids (<20 wt %) and either very low levels of cellulose gels or zero cellulose gels.

Utilization of these relatively low levels of food-grade acids is possible due to the hydrophilic nature of the natural fibers of the inner wall of a paper straw. As the liquid mixture is applied to the interior of the paper straw, the porous fibers absorb a small percentage of the mixture. This creates a tight bond between the dried mixture and the interior surface of the paper straw, so it, therefore, it is not necessary to utilize high levels of good-grade acids to facilitate the bond between the straw's dried lining and the straw's interior wall. Therefore, food-grade acids within the coating material are not added for adhesion purposes but only for flavoring and PH adjustment purposes.

There are several types of food grade acids that may be used. Citric acid is the most abundantly used acid in the food and beverage industry. While this acid was extracted from limes and lemons in the past, it can now be produced commercially with the help of fermentation process. Right from adding a sharp taste to sweets and cold drinks, to generating an optimum condition for forming desserts, jellies, and jams, citric acid has a widespread application. Food grade acetic acid is known for its pungent smell and is found in vinegar. It is very commonly used in pickling industry as the vinegar that is fermented naturally has variable pH and thus, Food grade acetic acid is used for creating pickling liquor that has a specified acidity. It is also used in flavorings and confectionary items. Fumric acid is a food acidulant that has a very strong taste. As it is not highly soluble, it only has some limited applications in the food and beverage industry. It is usually used in cheesecake mixes, dessert powders that contain gelatin, and powdered drinks. The strong flavor and reasonable price of fumaric acid make it an excellent choice for making feeds for animals. Lactic acid is commonly used for producing boiled sweets and pickled foods. It is also used in the form of raw material for manufacturing emulsifiers for the baking industry. While it can be produced synthetically as well as by fermentation, the latter is usually used by most chemical manufacturing companies. Phosphoric acid the second most commonly used acidulant in the food and beverage industry is phosphoric acid as it is used in producing cola drinks which are sold massively all over the world. This acid is known for its biting, harsh taste that perfectly complements the flavor of cola. Malic acid is naturally found in tomatoes, apples, bananas, cherries, etc. Its applications are similar to that of citric acid and are generally used for making beverages that have a low-calorie count. However, it is little expensive as compared to citric acid. Tartaric acid was very commonly used in the past. However, the majority of its applications are now replaced with citric acid. Its most common application is its use as raw material to manufacture bread improver emulsifiers. It can be manufactured synthetically as well as naturally.

In the disclosure, acid may be present in the matrix at less than about 20 wt %. Acid ranges can be from 1-19 wt %, 5-15 wt % or 8-2 wt %. The level of acid can be less than about 10 wt % in ranges such as 1-9 wt %, 2-8 wt % or 4-6 wt %.

Additionally, the disclosure is marked differently from the formulations of the conventional art due to the inherent properties of rigidity of paper or natural fibers-based drinking straws versus drinking straws made from other materials, most notably plastic in numerous forms. Paper straws are rigid, whereas plastic and similar straws have flexible walls. The prior art teaches methods to prevent over-drying via the addition of food-grade acids to prevent the interior lining from drying excessively drying and thus becoming brittle and thus shattering or cracking as the wall of a plastic or similar straw is flexed during packaging, shipping or handling. The disclosure also significantly reduces formulation complexity relative to this issue. The techniques taught by the prior art require a relatively tight tolerance relative to the amount of food acid required. Adding too much acid to the formula will prevent optimal drying of the lining, potentially resulting in the lining flowing out of the plastic straw during shipment. Additionally, lack of adequate drying of the lining could allow pathogens and bacteria to growing within the lining. Secondly, the under utilization of food acid in the techniques taught by the prior art result in an interior lining that become brittle and thus could fall out of the straw during cleaning, packaging, transport or use by the consumer. The disclosure outlined herein reduces complexity relative to these issues and the amount of food acid utilization, as over-drying of the lining during the curing process is virtually impossible. Additionally, the rigid properties of paper straws prevents flexing of the straw wall, thus eliminating formulation issue relative to the cracking of the lining.

The water content of the matrix may be relevant to the stability of the components. Typically, the coated straw will be dried to remove additional water and reduce the water content. Usually the straw's matrix will have a water content of less than 5%, preferably less than 3% and most preferably less than 1% by weight.

Another factor is water activity a_{w}. The definition of aw is

a_{w}=P/P*

where P is the partial water vapor pressure in equilibrium with the solution, and P* is the (partial) vapor pressure of pure water at the same temperature.

Advantageously, the matrix composition, when dried, will have a water activity of less than 0.6, and preferably less than 0.5, and more preferably less than 0.4.

The unique hydrophilic properties of paper straws, in contrast to the highly hydrophobic nature of plastic straws, allow for not only significantly lower food-grade acid utilization but also lower utilization of additional materials to assist in the handling of the material and to increase gelling of the material so that the material can adhere to the internal surface of the straw a prevent dripping after application. Because of the inherently porous nature of the paper fibers, a portion of the material is absorbed, thus creating a natural bond between the material and the inner wall of the straws. In contrast, the smooth, non-porous interior wall of a plastic straw makes it more difficult for the material to cling to the inner wall. The conventional art teaches the addition of cellulose gums to facilitate gelling of the utilized liming formulations to assist in the handling of the material and to reduce dripping and flow of the material once applied to the interior of the straw. The disclosure utilizes significantly lower levels of modified gums or no cellulose gums due to the inherent capability of this disclosure's coating material to naturally cling to the porous and hydrophilic interior of a paper straw.

The disclosure utilizes dextrin as the primary component of the matrix that is applied to the inside of the paper straw and is used for its unique properties to be soluble in both cold and warm beverages, in addition to its optimal properties to adhere to the inside wall of hydrophilic and porous fibers of the interior of a paper straw, and to create a ridged structure upon drying that increases the strength of the finished paper straw products, thus increasing durability of the product, thus reducing the possibility of damage during cleaning, handling, packaging, shipping, and handling.

Dextrins are a group of small carbohydrates formed when starch or glycogen, which are larger carbohydrate molecules, undergo hydrolysis. During hydrolysis, the bonds between glucose units in starch or glycogen are broken.

Dextrin made from wheat is specifically selected for this disclosure for wide availability, low cost, wide consumer acceptance, GRAS classification (FDA—21 CFR § 184.1277 Dextrin is under Listing of Specific Substances Affirmed as DIRECT FOOD 68 SUBSTANCES AFFIRMED AS GENERALLY RECOGNIZED AS SAFE), water solubility and clinging capabilities.

In particular, the clinging capabilities eliminate the need for acid etching of the straw's interior or the need to add large amounts of additional food-grade acids to increase the matrix's adhesion to the straw's interior wall. As the fibers of the dextrin interact with the fibers of the paper that make up the interior wall of the straw, bonds are created that assist in the adhesion of the matrix to the paper straw. Thus, due to this natural fiber-to-fiber bond created between the fibers of the dextrin and the fibers of the paper that makes up the interior wall of the straw, large amounts of additional food-grade acids to assist in adhesion are not needed.

The high degree of water solubility for dextrin also makes this substance optimal for use in this disclosure, especially as its use relates to the specific issues of attaching the matrix to the interior wall of the paper straw. Our experiments show this high degree of water solubility especially compared to cellulose gums and partially hydrolyzed guar gum (PHGG). For example, a sample amount of wheat dextrin (×grams amount) is completely soluble in only a 5× amount of 21° C. water, whereas as 10×, 12×, 15×, and 20× are needed for common cellulose gums of the art, hydroxypropyl methylcellulose, hydroxypropyl cellulose, methyl ethyl cellulose, methyl cellulose and carboxymethylcellulose. Dextrin is also superior to PHGG relative to water solubility. PHGG requires up to 12× to become fully water-soluble.

By using dextrin, this disclosure minimizes the use of water in the formulation to achieve water solubility of the primary matrix ingredient. By minimizing the amount of water in the formulation, this disclosure is able to reduce the amount of water wicked into the paper of the straw, preventing deformation during the manufacturing process and drying processes.

The formulation of the matrix of the disclosure may be gluten-free. Foods that are labeled gluten-free, according to the Food and Drug Administration rules, must have fewer than 20 parts per million of gluten.

Additionally, experiments demonstrate a gel using dextrin compared to a gel of similar viscosity made of PHGG yield significantly less water wicking in the fibers of the paper that makes up the interior wall of the drinking straw. Less water wicking yields less absorption of active ingredients into the paper, allowing for more of the dosed amount of the active ingredient to be available to the user of the paper straw. Please see Appendix B, for photos and a summary of our experiments relative to the relative wicking of water for a dextrin compared to PHGG.

Dextrin is also used in this disclosure because of its low cost and ease of availability. For example, dextrin can be easily purchased even a relative small weights at a price of between $0.02 and $0.04 per gram, whereas PHGG is typically five or more times more expensive. Modified cellulose gums, such as hydroxypropyl methylcellulose, hydroxypropyl cellulose, methyl ethyl cellulose, methyl cellulose and carboxymethylcellulose, are typically priced even higher.

The properties discussed above relative to water wicking—or reduced degree of—also add to the rigidity of the disclosure as the matrix is dried. As discussed, a matrix comprised of dextrin tends to stick to the inner wall of the paper straw with only a minimal amount of the matrix being absorbed. The rigidity of the dried dextrin reinforces the already rigid characteristics of paper straw, thus yielding a highly durable finished product, making cleaning the product before packing easier and preventing damage to the finished product during packaging, shipping, and handling by retailers and customer product users.

Thus, the use of dextrin in this disclosure is for a very different purpose compared to ingredients and matrix formulation philosophies of prior art, which are primarily designed to achieve a flexible dried matrix and will not crack or fall out as the wall of the plastic straws is flexed during processing, shipping or normal use.

The use of dextrin due to the properties of adhesion and strength outlined above also reduces the need to add additional large amounts of food-grade acids to prevent over-drying so that brittleness does not occur, which could cause cracking of the dried matrix that is attached to the interior wall of a straw. The conventional art teaches the use of relatively large amounts of food-grade acids to prevent over-drying. The disclosure also significantly reduces formulation and drying/curing complexities relative to this issue. The techniques taught by the prior art require a relatively tight tolerance relative to the amount of food acid required. Adding too much acid to the formula will prevent optimal drying of the lining, potentially resulting in the lining flowing out of the plastic straw during shipment. Additionally, lack of adequate drying of the lining could allow pathogens and bacteria to growing within the lining. Also, over drying of the lining will create a brittle lining that could be easily damaged as the walls of the plastic straw flex during the packaging, transport or removal of the product from the packaging as an overly drying lining is subject to cracking and falling out of the interior surface of the plastic straw. The disclosure reduces complexity relative to these issues, as over-drying of the lining during the curing process is virtually impossible. This not only facilitates ease of manufacturing and eliminates leakage during transport and storage, but also significantly reduces the possibility of pathogen growth.

The thickness of the coating should also be considered. Thicker coatings will typically take longer to dissolve (at the same dryness level). Coatings will typically be applied to a thickness of up to about 1 mm, e.g., 0.01-1 mm, more typically up to about 0.7 mm, e.g., about 0.05 to 0.7 mm. Usually the coating will have a thickness of up to about 0.5 mm, or up to 0.25 mm.

In a typical embodiment, the matrix may include 50-250 parts by weight of dextrin, 0-20 parts by weight of modified cellulose, and 0-50 parts by weight of edible acid. Due to the hydrophilic nature of the paper straw, little acid will be required. Thus in an embodiment that matrix may include 50-250 parts by weight of dextrin, 0-20 parts by weight of modified cellulose, and 0-10 parts by weight of edible acid. Other amounts of edible acid include about 1-10 parts, 1-5 parts, 1-2 parts, 0-5 parts and 0-2 parts.

A method of preparing a drinking straw of the disclosure is to start with an empty paper drinking straw. The matrix is prepared by dissolving the components in water to form a syrup, paste or slurry. The syrup, paste or slurry is applied to the internal surface of the drinking straw by dipping, spraying or capillary action. The drinking straw is then dried to result in a drinking straw with an interior surface coating with the dried matrix. A portion of the matrix is absorbed into the interior surface of the hydrophilic drinking straw.

The syrup, paste or slurry may be prepared at room temperature or at an elevated temperature less than the boiling point of water. Dextrin has a solubility of 0.1 to about 0.5 g/ml in hot water. Therefore, a dextrin solution can be prepared by dissolving, for example 1 gram of dextrin in 5 ml of water.

### EXAMPLES

### Example 1—Flavored Matrix for Paper Straw

A matrix for insertion into a per drinking straw was prepared as follows:

65 grams of dextrin was added to 40 ml of filtered 20c water to create a syrup. To this syrup, 9 grams of citric acid, 15 grams of cherry flavoring powder, 1 gram of food coloring, and 2 grams of stevia sweetener were added. The mixture was brought to 48c via a normal commercial culinary device typically used for a similar purpose. 2 grams of the resulting mixture was then added to each of 68 paper straws via a pressure vessel connected to tubing and a hollow needle. A mandrel was inserted into the paper straw to evenly disperse the matrix throughout the inner lining. The paper straw containing the matrix was then spun along its horizontal axis to further evenly distribute to the matrix. The 68 paper straws were then placed in a commercial dehydration unit at 32c until a hard shell was formed inside the paper straw.

### Example 2—Flavored Matrix with Active Ingredient for Paper Straw

A matrix for insertion into a per drinking straw was prepared as follows:

130 grams of dextrin was added to 78 ml of filtered 20c water to create a syrup. To this syrup, 16 grams of citric acid, 30 grams of orange flavoring powder, 6.4 grams of ascorbic acid, and 2 grams of stevia sweetener were added. The mixture was brought to 48c via a normal commercial culinary device typically used for a similar purpose. 1.5 grams of the resulting mixture was then added to each of 176 paper straws via a pressure vessel connected to tubing and a hollow needle. A mandrel was inserted into the paper straw to evenly disperse the matrix throughout the inner lining. The paper straw containing the matrix was then spun along its horizontal axis to further evenly distribute to the matrix. The 176 paper straws were then placed in a commercial dehydration unit at 32c until a hard shell was formed inside the paper straw.

### Example 3—Unflavored Matrix with Active Ingredient for Paper Straw

A matrix for insertion into a per drinking straw was prepared as follows:

162 grams of dextrin was added to 100 ml of filtered 20c water to create a syrup. To this syrup, 10 grams of citric acid, 14 grams water-soluble powder containing 2.9 grams of vitamin E oil, and 4 grams of stevia sweetener were added. The mixture was brought to 48c via a normal commercial culinary device typically used for a similar purpose. 1 gram of the resulting mixture was then added to each of 289 paper straws via a pressure vessel connected to tubing and a hollow needle. A mandrel was inserted into the paper straw to evenly disperse the matrix throughout the inner lining. The paper straw containing the matrix was then spun along its horizontal axis to further evenly distribute to the matrix. The 289 paper straws were then placed in a commercial dehydration unit at 32° C. until a hard shell was formed inside the paper straw.

### Example 4—Dextrin Versus PHGG

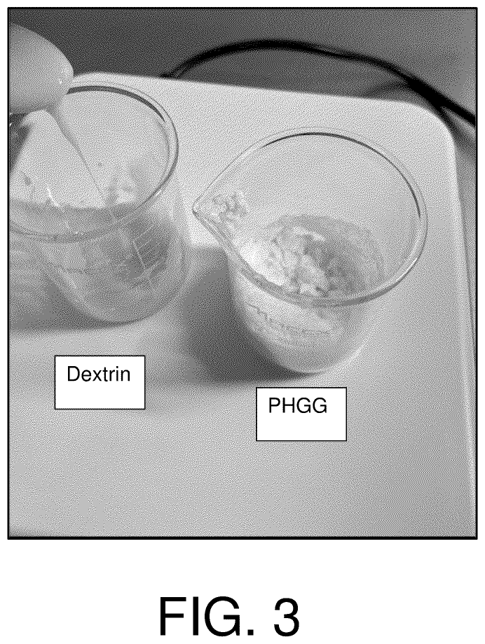

Thirty (30) grams of dextrin and 30 grams of PHGG were added to beakers. Thirty (30) grams of room temperature water was added to each and the mixture stirred. A free flowing paste suitable to coat the inside of a paper straw is created using dextrin. Up to five (5) times as much water is required to be added to PHGG to create a matrix syrup of similar viscosity. The Photo in FIG. 3 show the results of this experiment with the beaker on the left, which is the dextrin preparation, containing a flowing liquid compared to a nearly unwater-saturated mixture of PHGG on the right. Nearly five times as much water was needed to create a mixture of similar viscosity when PHGG is used as the primary ingredient of the matrix. The disclosure demonstrates that dextrin is a superior ingredient for paper straws because of this issue.

Due to the superior solubility of dextrin, preparation of a smooth syrup matrix is significantly faster and easier to create. As is outlined in the below photos, a syrup of similar viscosity was created using thirty (30) grams of each of dextrin and PHGG using five times as much water to fully hydrate the PHGG matrix. The preparation of dextrin creates a smooth matrix free of any clumps of material within two minutes with minimal stirring. In contrast, the preparation utilizing PHGG is not smooth and contains significant amounts of un-hydrated material even after applying more than ten (10) times to stirring and allowing for ten (10) minutes. Creation of a free flowing free of un-dissolved material is important as an un-dissolved material could clog production equipment. Additionally, the additional time required for PHGG solubility could result in production delays. If a PHGG based matrix is utilized before full solubility is achieved, lumps are likely to occur in the straw lining. Not only are lumps in the lining aesthetically unpleasing, but such lumps and unevenness can compromise the strength and integrity of the lining potentially leading to breakage and falling out to straw prior to use be the consumer. The disclosure demonstrates that dextrin is a superior ingredient for paper straws because of this issue.

### Example 5—Matrix Creation of Dextrin Versus PHGG

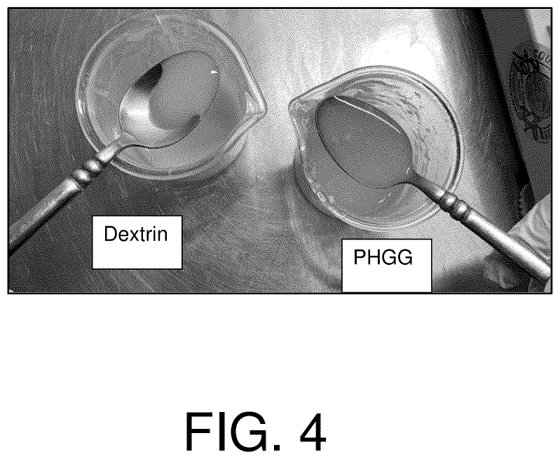

Thirty (30) grams of dextrin (left) and 30 grams of PHGG (right) were added to beakers. Thirty (30) grams of room temperature water was added to the dextrin beaker (left) and ninety (90) grams of room temperature water was added to the PHGG beaker (left). The dextrin beaker was stirred for sixty (60) seconds creating a smooth, free flowing syrup matrix suitable to coat the interior of a paper drinking straw. The PHGG beaker was stirred for three (3) minutes and allowed to set undisturbed for five (5) minutes. Subsequently, the PHGG beaker was stirred for an additional three (3) minutes and again allowed to set undisturbed for five (5) more minutes. Even though the PHGG beaker contained significantly more water, significantly more agitation was applied and significantly more time elapsed, the resulting syrup still contained a meaningful amount of un-dissolved PHGG. This can be seen in FIG. 4.

Thus, it is possible to create a matrix suitable to coating the interior of a paper straw utilizing significantly less water when dextrin is used. Because less water is required, less water penetrates the fibers of the interior wall of the paper. This is an important consideration as excess water penetration destroys the structural integrity of the paper making manufacturing more difficult and creating lower production yields. Additionally, less water yield faster drying times during the post-production period.

### Example 6—Water Penetration of Dextrin Versus PHGG

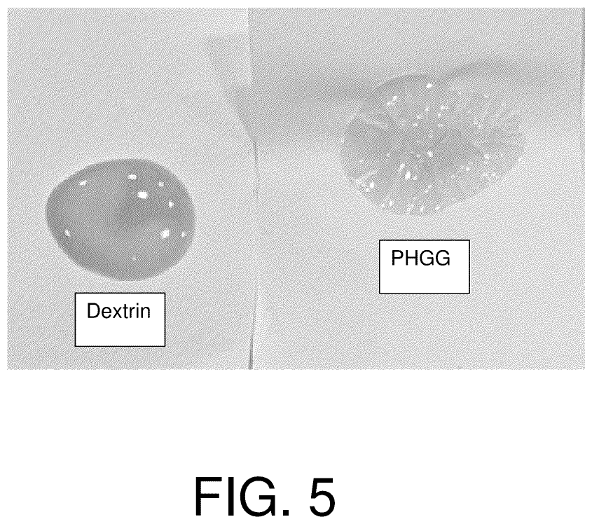

Using the matrix prepared in Example 5, the final gel matrixes were applied to paper. Five (5) grams of each of the dextrin and PHGG matrix were applied to paper and left undisturbed for three (3) hour. As is shown in FIG. 5, there is meaningfully less penetration of water into the paper below the dextrin based matrix compared to the PHGG matrix.

### Example 7—Drying of Dextrin Versus PHGG

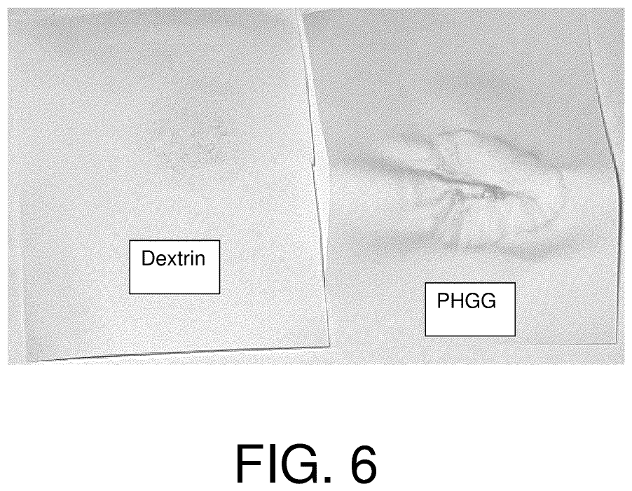

Five (5) grams of each of the dextrin and PHGG based matrix preparations prepared in Example 6 were place in paper and allowed to dry for three (3) hours. As can be seen in FIG. 6, the dextrin preparation (left) dries on top of the paper with minimal penetration into the paper (viewed from the underside). The dextrin based matrix (left) cause significantly less damage to the fibers of the paper compared the PHGG based matrix (right).

In addition to the desirable outcomes outlined in the examples above relative to less damage to the paper straw during manufacturing and faster drying times outlined above, the dextrin based matrix that allows for less water penetration into the fibers of the paper straws also potential yields better administration of active ingredients to the user of the paper straw. Using a matrix of dextrin, allows for less leaching of the active ingredient(s) into the fibers of the paper, allowing the ingredients to remain within the matrix and thus being available within the matrix for delivery to the user of the straw. While this issue is not important relative to plastic straws, which allow for zero water wicking, this is critical issue relative to paper straws especially when specific dosing tolerances for active ingredients must be maintained.

Relative to speed of water solubility, superior water wicking reduction, faster drying times, quicker matrix preparation times, superior preservation of the structural integrity of paper fibers, potential for reduced clogging of production equipment, and likely superior maintenance of active ingredients within the matrix, these disclosures demonstrates that dextrin is a superior ingredient for paper straws.

All of the compositions and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope and concept of the invention as defined by the appended claims.

What is claimed is:

1. A drinking straw comprising:
a hollow tube having an outside and an inside:
a matrix coating the inside, the matrix comprising dextrin; and
at least 1 flavor component in the matrix.

2. The drinking straw of claim 1, wherein the dextrin is fibrous water soluble dextrin.

3. The drinking straw of claim 1, wherein the hollow tube comprises paper formed from at least one of sugar cane fibers, hemp fibers, cellulose fibers or bamboo fibers.

4. The drinking straw of claim 1, wherein the matrix contains at least one sweetener.

5. The drinking straw of claim 1, wherein the matrix contains at least one edible dye.

6. The drinking straw of claim 1, wherein the matrix does not contain active ingredients selected from the groups consisting of pharmaceutical substances, botanical extracts and vitamins.

7. The drinking straw of claim 1, wherein the matrix has fewer than 20 parts per million of gluten.

8. The drinking straw of claim 1, wherein the hollow tube comprises paper and the matrix is partially absorbed by the paper.

9. The drinking straw of claim 1, wherein the matrix contains no cellulose gels.

10. The drinking straw of claim 1, wherein the flavor component contains at least one flavoring selected from the group consisting of cherry, strawberry, raspberry, blueberry, blackberry, apple, orange, pear, lemon, lime, vanilla, chocolate, mint and pistachio.

11. The drinking straw of claim 1, wherein the matrix contains at least one natural edible dye selected from the group consisting of annatto, caramel carmine elderberry juice, lycopene paprika and turmeric.

12. The drinking straw of claim 1, wherein the matrix contains at least one artificial edible dye selected from the group consisting of FD&C Blue No. 1, FD&C Blue No. 2, FD&C Green No. 3, FD&C Red No. 3, FD&C Red No. 40, FD&C Yellow No. 5, and FD&C Yellow No. 6.

13. The drinking straw of claim 1, wherein the hollow tube comprises an elongated tubular body made of multiple layers of paper.

14. A method of manufacturing a drinking straw, comprising:
providing a hollow tube having an outside and an inside;
preparing a matrix by dissolving dextrin in water to prepare a paste, slurry or syrup;
coating the inside of the tube with the paste, slurry or syrup; and
drying the coated matrix.

15. The method of claim 14, wherein the hollow tube comprises paper formed from at least one of cellulose fibers, sugar cane fibers, hemp fibers, or bamboo fibers.

16. The method of claim 14, wherein the matrix does not contain active ingredients selected from the group consisting of pharmaceutical substances, botanical extracts and vitamins.

17. The method of claim 14, wherein the matrix further comprises at least one of a dye or a flavoring.

18. The method of claim 14, wherein the matrix is prepared at about 20° C.

19. The method of claim 14, wherein the matrix is heated to about 48° C. before coating the inside of the tube.

20. The method of claim 14, wherein drying the matrix is performed at 32° C. until a hard shell or semi-hard shell is formed inside the drinking straw.
